(19) United States
(12) Patent Application Publication
(10) Pub. No.: US 2021/0178479 A1
(43) Pub. Date: Jun. 17, 2021

(54) TIMEPIECE COMPONENT

(71) Applicant: ROLEX SA, Geneva (CH)

(72) Inventors: Tuomas Jalanti, Geneva (CH); Hossein Meidani, Geneva (CH)

(73) Assignee: ROLEX SA, Geneva (CH)

(21) Appl. No.: 17/087,828

(22) Filed: Nov. 3, 2020

(30) Foreign Application Priority Data
Nov. 13, 2019 (EP) 19208971.2

(51) Int. Cl. B22F 10/20; B29C 64/153; B22F 12/10

(52) U.S. Cl. CPC B22F 10/20; B33Y 80/00; B22F 12/10; B29C 64/153

(57) ABSTRACT

A surface treatment process for manufacturing a metal- and/or cermet-based timepiece component from a component having irregularities, such as pores and/or precipitates and/or striations, obtained by a powder metallurgy or additive manufacturing method, which process includes a step of improving the surface finish of the component by superficial remelting on a surface zone of the component.

This application claims priority of European patent application No. EP19208971.2 filed Nov. 13, 2019, the content of which is hereby incorporated by reference herein in its entirety.

### INTRODUCTION

The present invention relates to a timepiece component for a timepiece as well as a manufacturing process for such a component. It also relates to a surface treatment process as such used in the manufacturing process for such a component. It also relates to a timepiece as such comprising such a timepiece component.

### PRIOR ART

In the timepiece manufacturing industry, the manufacture of a component, particularly for a timepiece decoration function, requires compliance with a number of constraints. First, the component must respect particular mechanical constraints, because of its expected functionality. In addition, it must achieve an irreproachable aesthetic appearance. Finally, it is often desired to provide a timepiece component of a particular, often complex shape in order to achieve a new overall aesthetic result and/or to meet a particular functionality effectively. Moreover, it is always preferable to propose a solution that allows such a timepiece component to be manufactured in a way that is compatible with large-scale production and marketing, including in alloy compositions that are difficult to obtain using conventional casting techniques. Finally, it is also often advantageous to obtain lighter components, in particular for precious metals with a high density.

In the end, existing solutions try to reach a compromise between all the above requirements. They are generally based on the use of metallic materials or metal alloys, in particular those based on noble metals, using traditional metallurgy, or on the use of ceramics. There is however a need to improve existing solutions to better meet the various requirements mentioned above.

Thus, the general purpose of the present invention is to propose a solution for the manufacture of a timepiece component which reaches an improved compromise between all the requirements mentioned above.

More precisely, a first object of the present invention is to propose a flexible solution for the manufacture of a timepiece component that makes it possible to form complex shapes while remaining compatible with the use of a maximum of different materials.

A second object of the present invention is to propose a solution for the manufacture of a timepiece component of irreproachable aesthetic appearance.

A third object of the present invention is to propose a solution for the manufacture of a timepiece component compatible with large-scale production.

A fourth object of the present invention is to propose a solution for the manufacture of a light timepiece component.

### BRIEF DESCRIPTION OF THE INVENTION

To this end, the invention is based on a surface treatment process for manufacturing a metal- and/or cermet-based timepiece component from a component comprising irregularities, such as pores and/or precipitates and/or striations, obtained by a powder metallurgy or additive manufacturing method, wherein it comprises a step of improving the surface finish of the component by superficial remelting on a surface zone of the component. It then comprises a step of finishing the surface of said surface zone of the component, this finishing step being performed after the step of improving the surface finish of the component by superficial remelting.

The invention also relates to a metal or cermet-based timepiece component for a timepiece, comprising a core comprising irregularities, such as pores and/or precipitates, wherein it comprises a surface zone having fewer irregularities than said core due to a surface treatment involving superficial remelting. Said surface zone may comprise a porosity rate lower than that of said core. The invention also relates to a timepiece, in particular a wristwatch.

The invention is more precisely defined by the claims.

### BRIEF DESCRIPTION OF THE FIGURES

These objects, features and advantages of the present invention will be set out in detail in the following description of a particular embodiment provided in a non-limiting way in relation to the attached figures among which:

FIG. 1 schematically represents the implementation of a step of improving a surface of a component by the LSM method according to an embodiment of the invention.

FIGS. 2 and 3 illustrate a few examples of absorptivity and reflectivity of materials as a function of certain wavelengths.

FIG. 4 represents the reflectivity of three samples of white gold having undergone different surface treatments.

FIG. 5 schematically illustrates the implementation of the step of improving the surface finish by an LSM process according to a variant of the embodiment of the invention.

FIG. 6 illustrates the invention implemented by way of example on a white gold middle.

FIG. 7 illustrates the invention implemented by way of example on a 316L steel-based plate.

FIG. 8 illustrates the invention by an enlarged view in the thickness of the 316L steel-based plate of FIG. 7.

FIG. 9 represents an example of implementation of the invention on a grade 5 titanium-based plate.

FIG. 10a shows a surface zone of the grade 5 titanium-based plate of FIG. 9 treated according to an embodiment of the invention.

FIG. 10b represents a surface zone of a grade 5 titanium-based plate similar to that of FIG. 10a but not treated according to the embodiment of the invention.

The invention is based on the first choice consisting in using as the first step in a manufacturing process for a timepiece component a powder metallurgy or additive manufacturing technique. Such a choice has the first advantage of allowing the formation of complex and varied shapes, including shapes for example not achievable by a traditional metallurgy process. On the other hand, this first choice also has the second advantage of allowing the use of a multitude of materials, and even alloys or combinations of elements impossible to obtain by another traditional process, for example certain metal alloys incompatible with traditional metallurgy. This first choice according to the invention thus makes it possible to respond partially to the objects of the invention.

However, these selected techniques have the specific feature of forming porous and often heterogeneous components with visible surface defects such as visible or perceptible irregularities, for example pores and/or precipitates and/or striations. As such, these selected techniques are therefore difficult to reconcile with timepiece manufacturing requirements. Moreover, it has become apparent that these defects are very difficult, if not impossible, to eliminate on components with complex shapes using conventional finishing techniques, such as grinding, polishing, electrochemical polishing, etc. The invention thus comprises a surface treatment which implements a step of improving the components obtained by said powder metallurgy or additive manufacturing techniques, in order to ultimately define an improved manufacturing process compatible with all timepiece manufacturing requirements.

The manufacturing process for a timepiece component according to an embodiment of the invention will now be detailed.

According to the embodiment of the invention, in a first step, a blank of the component is prepared, according to a known additive manufacturing or powder metallurgy process. This blank is in a shape very close to the final shape of the final component. It may however optionally undergo additional operations such as threading and/or re-machining, before or after the surface improvement step as detailed below. Thus, we will wrongly designate by component any component or any blank, reworked or not, which will undergo the surface improvement treatment as described below. This component can be made for example of metal, such as a stainless steel, an aluminum alloy, titanium, gold, or silver, etc. Alternatively, it can be made of cermet. The entire component can be of the same material, among those considered above. Alternatively, it can comprise a combination of different materials. By “a component made of a certain material” we mean a component comprising at least 50% by weight of said material, indeed at least 80% by weight of said material.

In powder metallurgy, powders can for example be obtained by spraying, milling, or a combination of these techniques. They can then be compacted, for example with a cold press, a hot press, an isostatic press and/or sintering. Known powder metallurgical methods include the metal injection molding (MIM) method and the spark plasma sintering (SPS) method.

Examples of known additive manufacturing techniques include selective laser melting (SLM), direct metal laser sintering (DMLS), electron beam melting (EBM), nano particle jetting (NPJ), metal binder jetting, laser engineered net shaping (LENS), and electron beam additive manufacture (EBAM).

Powder metallurgy and additive technologies applied to metals or cermets make it possible to obtain components with various geometries, as mentioned above. They also offer the advantage of allowing the use of alloy compositions or combinations of elements, or even combinations of different materials within the same component, which are impossible to synthesize by conventional techniques. For example, they make it possible to use a white gold alloy comprising by weight at least 75% of the element Au, between 13% and 17% of the element Cr, between 5% and 10% of the element Pd and between 1% and 5% of the element Fe, so that the colorimetric parameter b* of this alloy according to the CIE 1976 L*a*b* model is less than 10.

They also make it possible to use a composition comprising by weight between 90% and 98% WC and between 2% and 10% nickel or a composition of 18 ct gold with 2 to 25% TiN. They also make it possible to make a component consisting of a core of aluminum alloy and an outer layer of 316L stainless steel or outer layers whose composition varies according to the location on the surface, for example, for a middle, the horns, the case band, the bezel ring, etc., may be made of different alloys and/or cermets. This makes it feasible, for example, to obtain color gradients or a juxtaposition of different colors or different mechanical resistance.

However, the components obtained by these technologies all have a lower density than the density of a solid component in the same material, because they are porous. As a result, they generally do not have a satisfactory surface finish to allow their use in the field of timepiece manufacturing. Indeed, it results from the very nature of these technologies that irregularities are visible, or at least perceptible, on the surface of the components, in the form for example of pores, bumps, hollows, precipitates, and/or striations, etc. The fraction of porosities, and thus the amount of defects, depends on the material used and the manufacturing technology. However, none of the current technologies allows the production of completely defect-free components.

However, these defects negatively affect the appearance of the component, particularly for surfaces that are desired to be smooth, for example finished with a mirror polish. In addition, pores, precipitates and/or striations with dimensions in at least one direction greater than or equal to 1 μm (or even 0.5 μm) are a particular nuisance because surface finishing processes such as shot peening, mechanical polishing and/or chemical or electrochemical polishing do not eliminate them. Indeed, pores and precipitates, which have a diameter of up to 500 μm, will be revealed on a polished surface, causing comet tails, pitting and other aesthetic defects. More generally, for mirror polishing, irregularities such as pores and/or precipitates and/or striations of dimension greater than or equal to 0.5 μm are already likely to be perceived. The result is that the components obtained by the above-mentioned techniques remain unsatisfactory in their current state to form timepiece components, despite their advantages, and that traditional finishing processes are not suitable for reliably removing all their defects.

The invention therefore proposes to remove the above-mentioned defects resulting from the manufacture of the components according to the first step explained above, and implements a surface treatment process, comprising a step of improving the surface finish of the component, which will be detailed below.

According to an embodiment, the step of improving the surface finish of the component involves superficial remelting, in particular by laser, for example by a method known as laser surface melting (LSM). Alternatively, energy can be supplied to the component by a laser beam, by a plasma beam, by an electron or ion beam, or by an arc. For example, a surface made of Ti-6Al-4V material is treated in a helium atmosphere at 10⁻¹ Pa with a 60 kV electron beam with a current of 1 to 50 mA, a spot size of 10 to 100 μm, and a scanning speed of 0.1 to 1 m/s.

The step of improving the surface finish of the component by superficial remelting may involve the use of a laser whose section at the end of the laser beam has a substantially homogeneous energy distribution. Alternatively, it comprises the use of a plasma beam or an electron beam or an ion beam or an arc.

These treatments have the common feature of inducing a superficial remelting of the component, through the addition of energy, which eliminates pores and/or precipitates and/or striations on the surface of the component, while having little impact on the overall density of the part. These are treatments that act only on a surface zone of the component. Advantageously, these treatments can also simultaneously reduce the roughness of the part.

More precisely, laser treatment using the LSM method is based on the interaction of electromagnetic radiation with the component material. As a function of the energy density, i.e. the energy per unit area, of the laser beam, of its focus/defocus on or near the component surface and of the duration of the interaction, a portion of the energy is absorbed by a surface zone of the component. The component material in this surface zone is thus heated until the material melts.

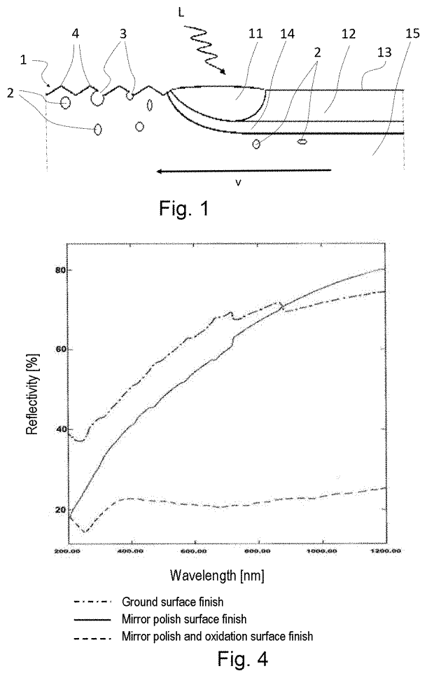

FIG. 1 is a schematic illustration of the treatment of a component surface by the LSM method. A component 1 was formed as explained above and comprises pores 2 forming surface defects 3, and surface striations 4. A laser L moves over the surface at a certain speed v (from right to left in FIG. 1) and melts the component material on a surface zone, forming a liquid bath 11. The method thus effectively implements a superficial remelting of a surface zone of the component 1. Pores and/or precipitates are eliminated in this bath 11. The result is a treated surface zone 12 of higher density and better quality, whose surface 13 has many fewer defects, if any. The treatment has little impact on the core 15 of the component, which therefore retains the initial pores 2 after the laser has passed. Finally, in an intermediate zone 14, between the surface zone 12 and the core 15, the material is not melted but its structure is modified by temperature diffusion during cooling and solidification of the bath 11.

The thickness of the bath 11, which corresponds substantially to that of the surface zone 12, is between 10 μm and 1 mm. Preferably, this thickness is greater than or equal to 50 μm, or even greater than or equal to 100 μm. Again preferably, it is less than or equal to 1000 μm, or even less than or equal to 500 μm, or even less than or equal to 200 μm, or even less than or equal to 100 μm.

In this LSM method, the laser speed v is optimized to obtain a bath 11 with predetermined dimensions and to ensure controlled solidification of the material. The surface zone 12 of the component is thus densified by this superficial remelting treatment. The intermediate layer 14 is a zone potentially impacted by the superficial remelting treatment: there may be a change in the microstructure of the material, even if the latter has not completely melted.

The energy and wavelength of the laser are preferably adapted to the nature of the component to be treated, in particular to the absorptivity and conductivity of its constituent material, and to the geometry of the object to be treated. If the laser energy is insufficient, the local temperature will not be sufficient to obtain a suitable liquid bath and all perceptible defects will not be eliminated. If the size of the liquid bath and/or the duration in the liquid phase before solidification are insufficient, the pores cannot rise to the surface properly, and/or the thickness of the layer free of perceptible pores is unsatisfactory. Furthermore, if the absorbed energy is too high, the geometry of the treated component may be modified, resulting in possibly large deformations and/or the generation of additional pores at the interface of the liquid bath with the material (keyhole), which are likely to be revealed during subsequent polishing. In addition, once the material has become liquid, the absorptivity increases strongly, which can also cause keyholing if the beam energy is too high.

Thus, by controlling the temperature gradients of the liquid bath and its cooling speed by the power distribution and/or the scanning and/or screening speed of the laser, it is possible to obtain the desired result and to eliminate the pores and possibly some inclusions of the remelted layer in the treated surface zone 12.

According to the embodiment, the scanning speed is chosen lower than that usually used by the LSM method, for example at least 10 times slower than that usually used, which is between 500 and 2000 mm/s, allowing the pores to migrate to the surface. Finally, the power, the space-time power distribution, the laser scanning speed and the screening as a function of the material and of the laser wavelength can be optimized to define the geometry of the liquid bath, and consequently the thickness of the treated surface zone, with minimal impact on the geometry of the component.

By way of example, an IPG® type laser of 2 kW power, with Trumpf® optics and a 3×3 square spot with an ILT Nozzle is used. The use of other similar equipment, particularly red or infrared lasers, is also possible, for example CO₂ lasers. Alternatively, blue, green, UV, etc. lasers can also be used.

The beam focusing and homogenization are advantageously adjusted according to a “top-hat” type spatial power distribution which is particularly advantageous. A “top-hat” type beam is a beam whose section end has the following specific feature: any point of said section has the same energy. In other words, a section at the end of the laser beam has substantially homogeneous energy distribution. In addition, the speed and screnning of the laser are set according to the energy required to obtain a liquid bath of the desired dimensions and to control the cooling rate of the liquid bath. Finally, the power of the laser is chosen to obtain a liquid bath whose depth is equal to or slightly greater than the thickness of the layer formed by the desired densified surface zone 12. This optimization of the process, in particular the optimization of the starting point, of the scanning pattern, of the scanning speed, of the number of passes, etc., of the laser makes it possible to eliminate the defects present in the material and to limit or even totally prevent the laser from generating new defects, for example deformations, distortions, splashes, etc.

Advantageously, this optimization takes into account the material and the shape of the component to be treated. Again advantageously, the laser parameters are also adapted to the geometry and/or the surface finish and/or the composition of the component. The speed and/or power and/or number of passes and/or screening can be modulated to take into account the specific geometry or composition of the component. Alternatively, a laser with a wavelength adapted to the specific reflectivity of the material to be treated can be selected, for example for gold or silver a laser with a wavelength less than or equal to 500 nm, respectively 350 nm.

Advantageously, the component can be tempered or cooled, either on the surface or globally, for example by means of a temperature-controlled support, in order to control the direction of solidification. Advantageously, the conditions are selected to promote a grain orientation substantially perpendicular to the outer surface of the treated component.

In one variant, the component is cooled by the use of a fluid or gas during or after the passage of the laser or throughout the process, for example a flow of a fluid adapted to a predetermined temperature. Cooling can be carried out directly after the laser treatment or in a delayed manner.

The table below gives some examples of parameters for an IPG laser as detailed above to implement the surface treatment, with injection of a shielding gas.

| | Pₗₐₛₑᵣ [W] | V [mm/min] | gas | Focus [mm] |
|---|---|---|---|---|
| 316L steel | 1500 W | 1000 | Ar or N₂ | 0 |
| White gold | 1500 W | 500 | Ar | 0 |
| Grade 5 | 1500 W | 1000 | Ar | 0 |
| titanium | | | | |

In another variant, the laser parameters are servo-controlled to a measurement of the temperature of the treated surface of the component, for example using optical pyrometry sensors, or any other suitable sensor.

Finally, the surface treatment process advantageously comprises a step of controlled cooling of the component comprising:
the use of a fluid or gas, or
the control of the temperature of the entire component, in particular by means of a temperature-controlled support, or
servo-control to a measurement of the temperature of the treated surface of the component.

As seen above, the interaction of a laser with the material is a complex phenomenon. The interaction of the laser radiation with the component to be treated is influenced not only by the nature of the laser and by the parameters of the laser process, as has been seen, but also by the characteristics of the constituent material of the component, in particular among its reflectivity, conductivity and absorptivity. This absorptivity of the material at the wavelength of the laser is one of the most important parameters. The lower the absorptivity, the less laser energy is “absorbed”, making it more difficult to melt the material.

The invention makes the observation that the absorptivity of the material to be treated has a direct impact on the dimension of the liquid bath and on the necessary energy to be supplied.

However, in certain cases it is observed that the absorptivity of the material is not adequate for the optimal implementation of superficial remelting.

For example, when the component is prepared in a metal or alloy typical of timepiece manufacturing, for example a metal based on gold, copper, silver, platinum, palladium, or aluminum, whose absorptivity is low, difficulties may be encountered. Indeed, the absorptivity of these materials at wavelengths above 700 nm is such that it generally does not allow an optimal interaction for example with a laser with a wavelength of 1064 nm.

It should be noted that, as mentioned above, increasing the laser power or the interaction time to compensate for a low absorptivity of a material could lead to geometrical deformations of the surface, for example deformations of the component due to its overall heating. This effect is not acceptable to form a timepiece component, and therefore it is not always possible to increase the laser power or change any other laser parameter.

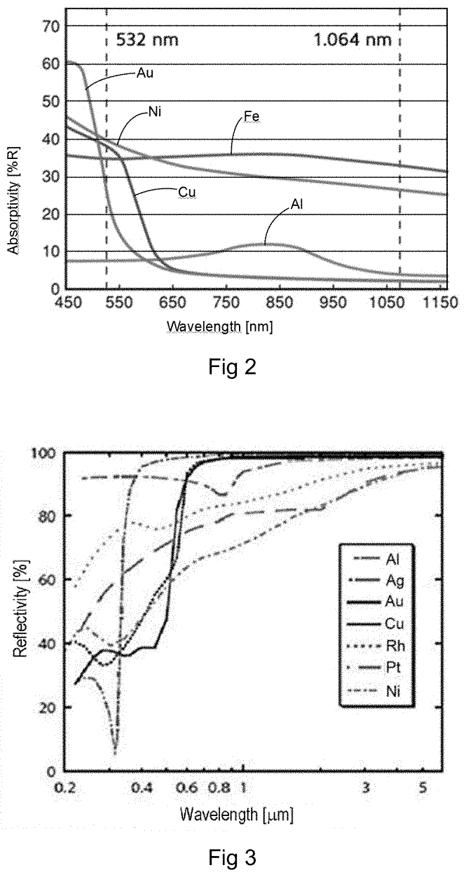

The graphs in FIGS. 2 and 3 show some examples of absorptivity and reflectivity of materials as a function of certain wavelengths.

These figures illustrate for example that for a YAG laser with a wavelength of 1064 nm, the average absorption of copper (Cu) is 10% and that of nickel (Ni) is 28%. For a CO₂ laser with a wavelength of ≈10 μm, the average absorption of copper is 1% and that of nickel is 4%.

According to the invention, it is taken into account that the absorptivity of a given wavelength by a material is an extreme surface phenomenon, which essentially concerns the first atomic layers and depends on the nature of the latter and/or the surface finish of the material. Consequently, variations in the surface finish, for example the presence of a certain roughness and/or porosity, or variations in the composition of the surface of the component, can impact the process.

It follows from the above observations that if the absorptivity of the material is low, and the energy supplied might not allow sufficient melting of the material, which manifests itself for example by an incomplete melting of the material or an insufficient size of the liquid bath, pores and/or precipitates and/or striations perceptible on the component surface may be insufficiently removed.

For example, for a white gold alloy (75.2 w % Au, 13.9 w % Pd, 3 w % Ag and 7.9 w % Cu, whose reflectance is about 75%) it has been observed that for a treatment with a 1500 W laser beam, type IPG® of 2 kW power, with Trumpf® optics and a 3×3 square spot with an ILT Nozzle, and a scanning speed of 500 mm/minute, the size of the liquid bath is not optimal.

To respond to these particular situations, the embodiment proposes to implement a preliminary step of modifying the absorptivity of the surface zone of said component. This preliminary step implements a preparation of the component surface in order to reduce the reflectivity part to the benefit of the energy absorption of the surface zone of the component to be treated thereafter. Thus, this surface preparation has for example the effect of modifying the behavior of this surface with respect to a laser beam during a future LSM treatment. Optionally, a surface absorptivity mapping can be performed beforehand in order to correlate the laser parameters. Optionally, the surface preparation is localized at the spot of initiation of the surface treatment process, in order to then exploit the change in absorptivity of the liquid bath relative to the solid surface.

According to a first variant embodiment, the preliminary step of surface preparation comprises a step of deposition of chemical elements in the form of a coating. This deposition advantageously provides a quantity less than or equal to 5 at % of chemical elements, in relation to the overall composition of the surface zone. The surface coating can modify the chemical nature and/or the color of said surface. Alternatively or simultaneously, the surface coating can modify the topology of the surface. The surface coating can be deposited, for example, by PVD, CVD, ALD, electroplating, sol-gel or SAM. The thickness of the surface coating can be greater than or equal to 0.1 nm, or even greater than or equal to 0.5 nm, or even greater than or equal to 1 nm, and less than or equal to 10 μm, or even less than or equal to 1 μm.

The table below illustrates a few examples made according to this first variant (for a YAG laser with a wavelength of 1064 nm).

| Substrate | Surface coating | | | Thickness densified |
|---|---|---|---|---|
| material | material | thickness | | with coating |
| 950Pd | Fe | 10 | μm | 1000 μm |
| 950Pt | Ru | 5 | μm | 500 μm |
| Au750Ag45Cu | Ni | 1 | nm | 500 μm |
| AlSi10Mg | TiN | 0.5 | nm | 200 μm |
| CuSn5 | Sn | 10 | nm | 100 μm |

The surface coating can be deposited by a physical vapor deposition (PVD) method, or by a chemical vapor deposition (CVD) method, or by an atomic layer deposition (ALD) method, or by electrodeposition, or by a sol-gel process, or by self-assembled monolayers (SAM).

This surface preparation can temporarily or permanently modify the color of the surface.

Advantageously, the thickness of the deposited coating is greater than or equal to 0.1 nm, or even greater than or equal to 0.5 nm, or even greater than or equal to 1 nm. In addition, this thickness is preferably less than or equal to 10 μm, or even less than or equal to 1 μm.

In all cases, the coating will modify the initial absorptivity of the component material and promote the future step of improving the surface finish. It should be noted that the effect of this coating remains proportionally negligible on the properties of the material of the component, and in particular the added material does not significantly modify the composition of the treated surface zone and does not modify the mechanical behavior of the material.

According to a second variant embodiment of the preliminary surface preparation step, chemical or electrolytic etching of the component surface can be carried out. For example, a nitro-hydrochloric acid etching (Aqua Regia) on a gold alloy decreases the reflectivity of the surface. The layer modified by this preparation has advantageously a thickness comprised between 0.1 nm and 10 μm, or even between 0.5 nm and 1 μm.

According to a third variant embodiment of the preliminary surface preparation step, micro-texturing of the surface, for example by sandblasting, by bead blasting, by grinding, by laser treatment or by any other appropriate technique, is carried out to reduce the reflectivity of the surface.

According to a fourth variant embodiment of the preliminary surface preparation step, it is possible to modify the initial solid-state absorptivity of the surface of the component material by carrying out oxidation, nitridation, bonding, chlorination, fluorination, or sulfidation. Such a preparation may for example increase the roughness of the surface or change its color. With this fourth variant, the thickness of the modified layer is of the same order of magnitude as that of the above-mentioned coating. In addition, the contribution of chemical elements remains very low. Indeed, this contribution of chemical elements remains less than or equal to 5 at % of the total composition of the surface layer, i.e. the surface zone to be treated.

By way of example, the surface of a gold alloy-based component can be oxidized. For example, a white gold component (75.0 w % Au, 7.0 w % Pd, 15.0 w % Cr and 3.0 w % Fe) can be surface oxidized beforehand, for example by heating it for 15 minutes at 700° C. in an air furnace. An oxidized layer of approximately 100 nm is obtained.

Tests were carried out on three samples of 18-carat white gold, which were polished according to the usual techniques, to paper P320 (ground surface) and then to P4000 paper (mirror polished). One of the mirror-polished samples is then oxidized for 15 minutes at 700° C. in air. The reflectivity of the three samples is then measured using a UV Visible IR spectrophotometer. The results obtained are detailed in the table below and in FIG. 4:

| | | Estimated |
|---|---|---|
| Wavelength | Surface finish | reflectivity |
| 1064 nm | Mirror polished P4000 | ≈75% |
| 1064 nm | Ground R320 | ≈70% |
| 1064 nm | Mirror polished P4000 + | ≈25% |
| | oxidation | |

These tests illustrate that oxidation can decrease the reflectivity of the metal from 70% or 75% reflectivity for the non-oxidized state to less than 30% reflectivity, by generating an oxide layer of a thickness of 100 nm.

Moreover, it appears that on the previously oxidized surface of a white gold alloy object (75.2 w % Au, 13.9 w % Pd, 3 w % Ag and 7.9 w % Cu), a 1500 W laser at 500 mm/min eliminates the perceptible pores without affecting the geometry of this object, whereas the same treatment produces an insufficient effect on the pores present on the non-oxidized material. Advantageously, the treatment is carried out in the presence of a gas or a mixture of gases, for example a reducing gas or a mixture of reducing gases (even weakly reducing), in order to eliminate the oxygen from the surface layer of the precious alloy. This makes it possible not to change the final composition of the component.

As a final variant, the different preparation variants mentioned above can be combined with each other.

This preliminary step of surface preparation, although optional, brings in any case a very favorable effect for the subsequent step of improving the surface finish of the component. Indeed, the increase in absorptivity promotes the initialization of a superficial remelting, from the initial solid state. Moreover, it has been observed that by increasing the initial absorptivity of the surface of the component material, one obtains, for a given laser (for example a 1064 nm laser), a deeper melting bath than for an unprepared surface of the same component. The preparation step thus increases the efficiency of the surface improvement step and eliminates surface defects to an appropriate depth, without bringing an excess of energy that could impact the geometry of the component.

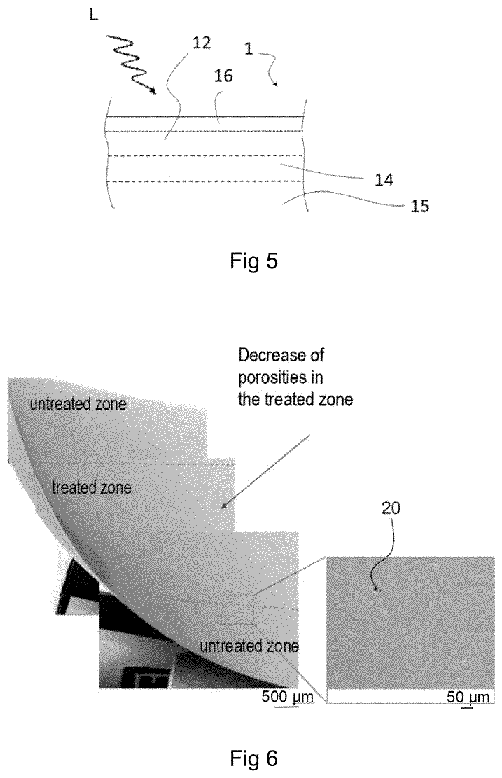

FIG. 5 schematically illustrates the implementation of the step of improving the surface finish by an LSM process after the implementation of a surface preparation step by coating or oxidation. The component 1 comprises a surface coating or oxidation layer 16, superimposed to a surface zone 12 intended to be treated, superimposed itself to an intermediate zone 14 between said surface zone 12 and to the core 15 of the component. During treatment with a laser L, the coating or oxidation layer 16 and the surface zone 12 will be melted simultaneously, promoted by the coating or oxidation layer 16, and the intermediate zone 14 will be thermally impacted but not melted. It should be noted that after the surface improvement treatment, the coating or oxidation layer 16 will have disappeared, merging with the surface zone 12.

Such a surface preparation is of particular interest for components based on gold, copper, silver, platinum, palladium, aluminum or alloys thereof.

Naturally, in a variant embodiment, the preliminary preparation step can be applied on only a part of the surface of the component, in particular on the process initiation zone.

The step of improving the surface of a component, as described above, ultimately provides the following two advantageous effects:
It makes the surface of a porous component compatible with traditional finishing processes, which further improve the appearance of the surface finish;
It densifies the surface of the component with respect to its core, thus offering the possibility of lightening the component compared with a component obtained from solid material.

Preferably, the surface treatment process according to the embodiment of the invention may comprise a subsequent finishing step. This step is of particular interest for the manufacture of decorative timepiece components, for which surface finish requirements are very high.

In particular, this finishing step includes a step of grinding, machining or polishing the surface of said surface zone of the component. Preferably, this finishing step consists of polishing.

It should be noted that a polishing step may be necessary several times, not only during manufacturing, but also thereafter during maintenance operations, to remove scratches. This polishing is also very demanding if a mirror effect is to be ultimately achieved, which may require the removal of material up to a thickness of about 50 μm, or even more, depending on the depth of the scratches. It is therefore necessary that the treated surface zone of the component has a sufficient thickness to allow such a later finishing step. This thickness can therefore be predefined according to the desired final surface finish and in a manner compatible with normal maintenance operations.

Advantageously, the thickness of the treated surface zone may be greater than or equal to 100 μm, or even greater than or equal to 200 μm, or even greater than or equal to 500 μm, or even greater than or equal to 1000 μm.

In all cases, the surface treatment process as described above can be used to treat the entire surface of a component, or to treat only part of this surface.

The invention has been described in the context of a process for manufacturing a timepiece component, which comprises a first step of manufacturing a metal- or cermet-based component by a powder metallurgy or additive manufacturing method, before implementing a process of surface treatment of said component obtained by the first step. The invention also relates to this surface treatment process as such.

The manufacturing process described above therefore makes it possible to obtain advantageous timepiece components, as described above. Such components can be particularly light, can take complex shapes, and/or can be based on original combinations of elements or materials. For example, the manufacturing process makes it possible to reduce the weight of a timepiece component that could also be manufactured by an existing traditional process, while maintaining a dense surface layer of the same appearance. Depending on the alloys and/or the geometry of the component, a significant weight gain can thus be obtained, for example by 20%, or even 30% or even more.

The invention thus relates to a timepiece component as such. Such a timepiece component for a timepiece is based on metal and/or cermet, comprises a core comprising irregularities, such as pores and/or precipitates, as a result of its manufacture by a powder metallurgy or additive manufacturing method, and comprises a surface zone having fewer irregularities than said core due to the fact that it has undergone a surface treatment involving superficial remelting.

According to the embodiment of the invention, the core and the surface zone of the timepiece component have roughly the same chemical composition.

The surface zone may therefore have a lower porosity rate than the core. The surface zone may also contain precipitates of lower density and/or smaller size than the core precipitates.

The core of the timepiece component may be porous, with a density less than or equal to 99.5% and the surface zone may have a porosity rate strictly higher than that of said core and/or a density greater than or equal to 99.9%. The density represents a percentage of the density of the same solid material.

The surface zone may have a porosity rate of size greater than 0.5 μm less than or equal to 0.1%.

The surface zone may extend to a depth greater than or equal to 20 μm, or even greater than or equal to 50 μm, or even greater than or equal to 100 μm. This depth therefore corresponds to the thickness of the layer formed by the surface zone. It is understood as the minimum or average value.

The surface zone may extend to a depth less than or equal to 1000 μm, or even less than or equal to 500 μm, or even less than or equal to 200 μm, or even less than or equal to 100 μm.

The surface zone of the component may extend over only part of or the entire surface of the timepiece component.

The timepiece component can be based on austenitic stainless steel, or based on titanium alloys, or based on precious metal alloys, or based on copper alloys.

The timepiece component can be based on metals with low absorptivity, less than or equal to 30%, and/or high thermal conductivity, such as a metal among Au, Al, Cu, Pt, Pd and alloys thereof.

The timepiece component can be a middle, a back plate, a bezel, a crown, a bracelet link, a clasp, a hand, or an applique.

The invention also relates to a timepiece, in particular a watch, such as a wristwatch, comprising at least one timepiece component as described above.

Advantageously, the initial porosity of the component is selected to obtain a component of predetermined density. The process according to the invention makes it possible to densify only the surface layer, i.e. the above-mentioned surface zone, making it possible to obtain lighter components with improved aesthetics. Furthermore, as the surface layer is of the same material as the porous core, there is no interface problem that would be likely to be encountered with traditional coatings such as plating.

The invention is illustrated below by three examples that allow the manufacture of a timepiece component.

According to the first example, a white gold middle (75.2 w % Au, 13.9 w % Pd, 3 w % Ag and 7.9 w % Cu) is manufactured using the SLM process described above. Prior to any treatment, the surface of the SLM-treated middle has between 0.5 and 2% porosity consisting of pores larger than 0.5 μm, and an absorptivity of roughly 20%. The middle is then oxidized for 15 minutes at 700° C. under air, which generates an oxidized layer of roughly 100 nm. This step corresponds to a preparation step of the treatment process according to the invention described above. Next, a 2 kW IPG laser with Trumpf® optics and a 3×3 square spot with an ILT Nozzle at a power of 1500 W (top hat) is scanned over the surface of the middle, with an average scanning speed of 500 mm/min and under argon flux. The distance between the laser and the surface to be treated is adjusted so that the surface is at focal plane level. This last step corresponds to the step of improving the surface finish of the component by superficial remelting on a surface zone of the component according to the invention. A middle without perceptible surface pores and/or precipitates is obtained. The thickness of the densified layer is 200 μm and has less than 0.1% porosity consisting of pores larger than 0.5 μm.

FIG. 6 illustrates this example by comparing an untreated zone of the middle with a treated zone. The enlargement of the untreated zone shows defects 20 which have disappeared after implementation of the surface treatment process according to the embodiment of the invention.

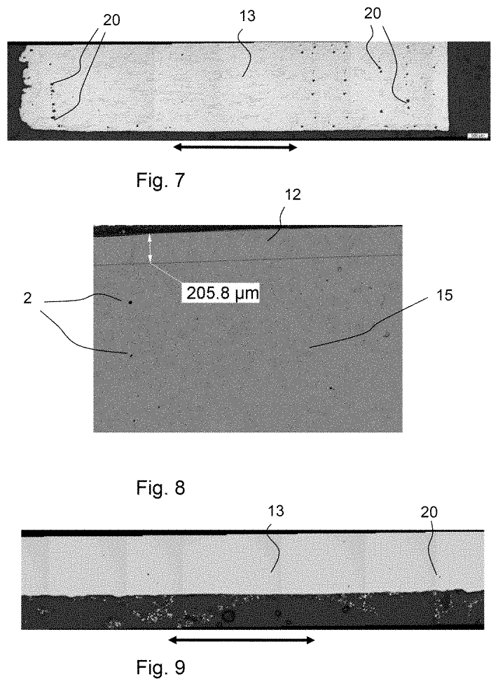

In the second example, a 316L steel plate manufactured by selective laser melting (SLM) is treated according to the invention. Prior to its treatment, the surface of the 316L steel plate has between 0.5 and 2% porosity consisting of pores larger than 0.5 μm. A 2 kW IPG laser with Trump® optics and a 3×3 square spot with an ILT Nozzle at a power of 1500 W (top hat) is scanned on the plate surface with an average scanning speed of 1000 mm/min and under nitrogen flow. The distance between the laser and the surface to be treated is adjusted so that the surface is at the focal plane. A plate without perceptible pores and/or precipitates on the surface is obtained. The thickness of the densified layer is about 200 μm and has less than 0.1% porosity consisting of pores larger than 0.5 μm. This example is illustrated by FIGS. 7 and 8.

FIG. 7 shows the surface of the 316L steel-based plate. This surface includes untreated zones with several visible defects 20. It includes a zone 13 treated by the surface treatment process according to the invention, which no longer includes these defects 20. FIG. 8 shows an enlarged view in the thickness of the 316L steel-based plate according to the invention. This component comprises a dense and defect-free surface zone 12 and a less dense core 15 comprising porosities 2.

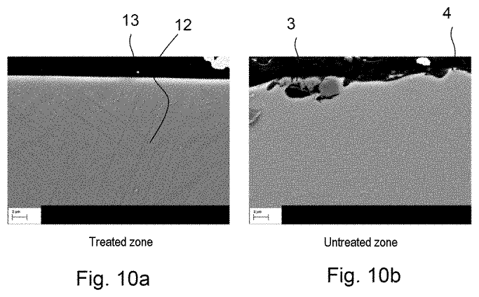

In the third example, a Grade 5 Titanium plate manufactured by selective laser melting (SLM) is treated according to the invention. Before treatment, the surface of the Grade 5 titanium plate has between 0.2 and 1% porosity consisting of pores larger than 0.5 μm. A 2 kW IPG laser with Trumpf® optics and a 3×3 square spot with an ILT Nozzle at a power of 1500 W (top hat) is scanned over the surface of the plate with an average scanning speed of 1000 mm/min and under argon flux. The distance between the laser and the surface to be treated is adjusted so that the surface is at focal plane level. A plate without perceptible pores and/or precipitates on the surface is obtained. The thickness of the densified layer is 300 μm and has less than 0.1% porosity consisting of pores larger than 0.5 μm. This example is illustrated by FIGS. 9 and 10.

FIG. 9 illustrates, for example, the surface of the grade 5 titanium-based plate. This surface includes untreated zones with several visible defects 20. It includes a zone 13 treated by the surface treatment process according to the invention, which no longer includes these defects 20. FIGS. 10a and 10b show enlarged views of the surface zones of the grade 5 titanium-based plate treated according to the invention and untreated, respectively. The surface zone 12 treated according to the invention, visible in FIG. 10a, is free of defects, both in its thickness and on its surface 13. In contrast, the untreated zone, visible in FIG. 10b, contains defects, such as surface pores 3 and striations 4.

1. A surface treatment process for manufacturing a metal- and/or cermet-based timepiece component from a component comprising irregularities, obtained by a powder metallurgy or additive manufacturing method, wherein the process comprises:
improving the surface finish of the component by superficial remelting on a surface zone of the component, and
finishing the surface of the surface zone of the component,
wherein the finishing is carried out after the improving the surface finish of the component by superficial remelting.

2. The surface treatment process as claimed in claim 1, wherein the surface zone of the component comprises a depth greater than or equal to 50 μm.

3. The surface treatment process as claimed in claim 1, wherein the surface zone of the component has an average depth less than or equal to 1000 μm.

4. The surface treatment process as claimed in claim 1, wherein the process comprises, prior to the improving and the finishing, modifying the absorptivity of the surface zone the component by a prior surface preparation in order to reduce the reflectivity part to the benefit of the energy absorption of the surface zone.

5. The surface treatment process as claimed in claim 4, wherein the prior modifying comprises depositing chemical elements in the form of a surface coating, wherein the depositing provides a quantity of chemical elements less than or equal to 5 at % with respect to an overall composition of the surface zone.

6. The surface treatment process as claimed in claim 4, wherein the prior modifying, comprises all or part of the following actions:
chemical or electrolytic etching of the surface; or
surface micro-texturing to reduce the reflectivity of the surface of the surface zone of the component.

7. The surface treatment process as claimed in claim 4, wherein the prior modifying comprises performing an oxidation, nitridation, boriding, chlorination, fluorination or sulfidation treatment modifying the absorptivity of the surface of the surface zone of the component.

8. A process for manufacturing a timepiece component, wherein the process comprises:
manufacturing a metal- and/or cermet-based component by a powder metallurgy or additive manufacturing method, and
implementing on the component the surface treatment process as claimed in claim 1.

9. A metal- and/or cermet-based timepiece component for a timepiece, comprising:
a core having irregularities, and
a surface zone having fewer irregularities than the core as a result of having performed a surface treatment involving superficial remelting according to the process as claimed in claim 1.

10. The timepiece component for a timepiece as claimed in claim 9, wherein the core and the surface zone of the timepiece component are made of substantially the same material.

11. The timepiece component for a timepiece as claimed in claim 9, wherein at least one of the following:
the surface zone has a porosity rate lower than a porosity rate of the core,
the surface zone comprises precipitates of lower density and/or lower size than those of the precipitates of the core,
the core is porous, of density less than or equal to 99.5% and the surface zone has a porosity rate strictly higher than a porosity of the core and a density greater than or equal to 99.9%.

12. The timepiece component for a timepiece as claimed in claim 7, wherein the surface zone has a porosity rate of size greater than 0.5 μm less than or equal to 0.1%.

13. The timepiece component for a timepiece as claimed in claim 9, wherein the surface zone extends over a depth greater than or equal to 50 μm.

14. The timepiece component for a timepiece as claimed in claim 9, wherein the surface zone extends over an average depth less than or equal to 1000 μm.

15. The timepiece component for a timepiece as claimed in claim 9, wherein the surface zone of the component extends over all or part of the surface of the timepiece component.

16. The timepiece component for a timepiece as claimed in claim 9, wherein the component is based on austenitic stainless steel, or based on titanium alloy, or based on precious metal alloy, or based on copper alloy.

17. The timepiece component for a timepiece as claimed in claim 9, wherein the component is based on metals with low absorptivity of less than or equal to 30%, and/or with high conductivity.

18. The timepiece component for a timepiece as claimed in claim 9, wherein the component is a middle, a back plate, a bezel, a crown, a bracelet link, a clasp, a hand, or an applique.

19. A timepiece, comprising the timepiece component as claimed in claim 9.

20. The surface treatment process as claimed in claim 6, wherein the prior modifying comprises performing surface micro-texturing by at least one selected from the group consisting of sandblasting, bead blasting, grinding, and laser treatment, to reduce the reflectivity of the surface of the surface zone of the component.
